(19) United States
(12) Patent Application Publication
(10) Pub. No.: US 2006/0248577 A1
(43) Pub. Date: Nov. 2, 2006

(54) Using SSO processes to manage security credentials in a provisioning management system

(75) Inventors: Antranig Edward Beghian, Toronto (CA); Adrian Faur, Richmond Hill (CA)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 11/117,897

(22) Filed: Apr. 29, 2005

(51) Int. Cl. H04L 9/32

(52) U.S. Cl. 726/5

(57) ABSTRACT

A method, apparatus, and computer program product are provided for using single sign-on (SSO) processes to manage security credentials in a provisioning management system. Service access operations are provided that embed credential operations and matching algorithms. Credential operations are treated at different levels of abstraction and define separate services to deal with authentication and authorization aspects. This is performed in order to be able to plug-in an external credential repository, which may be authentication/authorization provided by a third party entity.

### BACKGROUND OF THE INVENTION

1. Technical Field

The present invention relates generally to the management of security credentials. Still more particularly, the present invention uses Single Sign-on (SSO) processes to manage security credentials in a provisioning management system.

2. Description of Related Art

Data security is the science and study of methods of protecting data in networked systems, and to include cryptographic controls, access controls, information flow controls, inference controls, and procedures for backup and recovery. Complete security infrastructures are now used in practice, such as the Kerberos authentication service and more ambitious key and credential management systems known as Public-Key Infrastructures (PKI).

However, providing security within networked information systems goes far beyond protecting data, cryptographic keying material, and credentials. The transition from a mainframe-based computing infrastructure, through client/server architectures, to global connectivity in today's Internet has resulted in a vast array of new security threats and challenges. Indeed, it is difficult to define exactly what is meant by “security”—it is generally intended to vaguely mean protection “of valuable things” and “against bad actions”.

More formally, security is usually defined relative to a security policy, which defines actions, typically related to accessing resources (memory reads/writes, the CPU, communications ports, input-output devices, etc.), as allowed or disallowed. Methods, tools or procedures enforcing policies are called security mechanisms. A system is in either an allowed state (secure) or not; these states are precisely defined in theory. Attacks are actions which may cause security violations (movements to non-secure states). The security objective is to prevent, detect and/or recover from attacks.

In practice, of course, the situation is far less clear. Policies are often imprecise and incomplete common-language descriptions of what users, administrators, and outsiders are allowed to do. Typically they are neither explicitly formulated nor written down—in part due to the failure to understand the need for a security policy, and the difficulty of properly formulating one. Even experts find it challenging to accurately assess all relevant threats (potential violations of security) in a particular environment. Due to their large numbers and changing natures, it is virtually impossible to stay abreast of all relevant types of attacks, levels at which attacks may occur, exploitable implementation details, and complex protection mechanisms available.

In this design, credentials are defined in a protocol end points (PEP) context only. A credential management function/view outside its protocol end points definition is not possible. Protocol end points are the slots to access a service and represent the binding between a service and a physical device, and the fact that a credential cannot exist outside this context lead to almost no credential management functions.

The goal for this design is to replace the approach when managing credentials requires a special property (searchKey) to be defined in order to define a simplistic matching algorithm: two protocol end points can communicate only if they share the same search key. Service denial is usually more complex and a hierarchical domain structure is more appropriate to describe it than a hashing algorithm.

Thus, it would be advantageous to have a new design for services and their related entities, such as access points and credentials, to manage security credentials.

### SUMMARY OF THE INVENTION

Embodiments of the present invention provides a method, apparatus, and computer program product for using SSO processes to manage security credentials in a provisioning management system. Embodiments of the present invention provide service access operations that embed credential operations and matching algorithms. Embodiments of the present invention treat credential operations at a different level of abstraction and define separate services to deal with authentication and authorization aspects. This is performed in order to be able to plug-in an external credential repository, which may be authentication/authorization provided by a third party entity.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which embodiments of the present invention may be implemented;

FIG. 2 is a block diagram of a data processing system that may be implemented as a server in accordance with an embodiment of the present invention;

FIG. 3 is a block diagram of a data processing system in which embodiments of the present invention may be implemented;

FIG. 4 is a functional block diagram of a security management system in accordance with an embodiment of the present invention;

FIG. 5 is a diagram depicting how the credential management system creates SAP static definitions in accordance with an embodiment of the present invention;

FIG. 6 is a diagram depicting a further description of host and client SAP configuration in accordance with an embodiment of the present invention;

FIG. 7 is a diagram depicting software module SAP configuration in accordance with an embodiment of the present invention;

FIG. 8 is a diagram depicting authorization domain configuration in accordance with an embodiment of the present invention;

FIG. 9 is a diagram depicting the configuration of end points when a server is added to a cluster in accordance with an embodiment of the present invention;

FIG. 10 is a diagram depicting SAP and end point configuration at the time a piece of software is installed in accordance with an embodiment of the present invention;

FIG. 11 is a diagram depicting the addition of a configuration to an external vault in accordance with an embodiment of the present invention;

FIG. 12 is a diagram depicting the configuration of the internal vault in accordance with an embodiment of the present invention;

FIG. 13 is a diagram depicting the modification of a PEP credential in accordance with an embodiment of the present invention;

FIG. 14 is an authorization object model that is used in managing security credentials in accordance with an embodiment of the present invention;

FIG. 15 is a flowchart illustrating the operation of obtaining host accessibility from a client in accordance with an embodiment of the present invention;

FIG. 16 is a flowchart illustrating the operation of checking client access credentials to an authentication domain in accordance with an embodiment of the present invention;

FIG. 17 is a flowchart illustrating the operation of checking host accessibility from a client domain in accordance with an embodiment of the present invention;

FIG. 18 is a flowchart illustrating the operation of creating a new domain at the host in accordance with an embodiment of the present invention;

FIG. 19 is a flowchart illustrating the operation of installing and configuring a software resource on a host in accordance with an embodiment of the present invention;

FIG. 20 is a flowchart illustrating the operation of installing and configuring a software resource on a client in accordance with an embodiment of the present invention;

FIG. 21 is a flowchart illustrating the operation of selecting an authentication domain in accordance with an embodiment of the present invention;

FIG. 22 is a flowchart illustrating the operation of creating an initial authentication domain in accordance with an embodiment of the present invention;

FIG. 23 is a flowchart illustrating the operation of initializing external vault credentials in accordance with an embodiment of the present invention; and

FIG. 24 is a flowchart illustrating the operation of assigning a domain to a client in accordance with an embodiment of the present invention.

### DETAILED DESCRIPTION OF THE PREFERRED EMBODIMENT

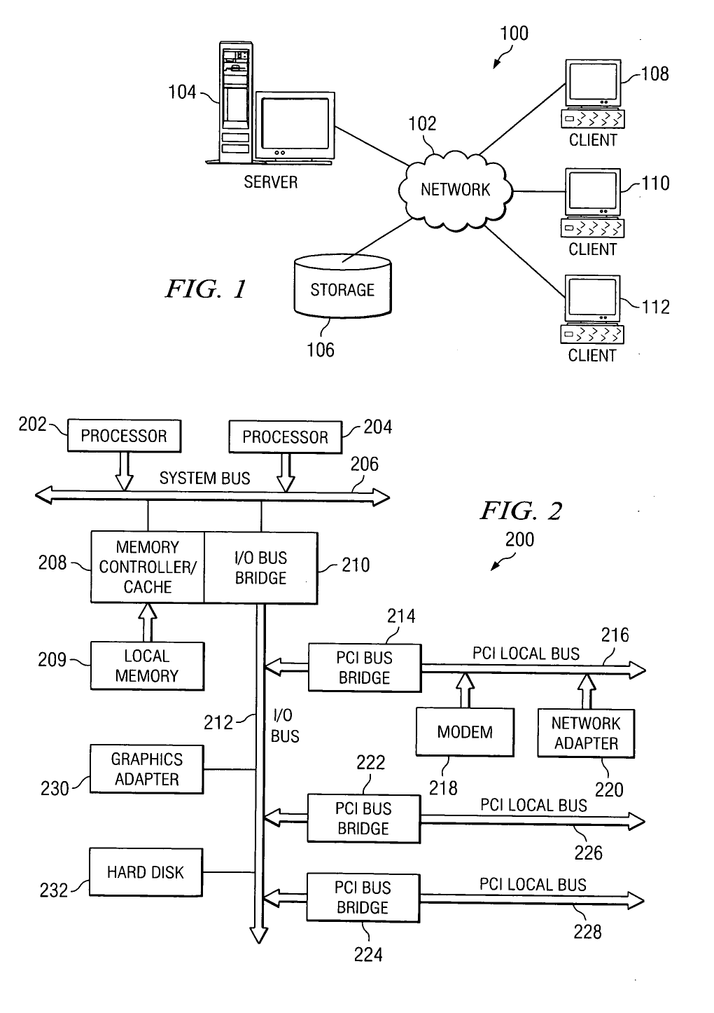

Embodiments of the present invention provide a method, apparatus, and computer program product for using SSO processes to manage security credentials in a provisioning management system. The data processing device may be a stand-alone computing device or may be a distributed data processing system in which multiple computing devices are utilized to perform various aspects of embodiments of the present invention. Therefore, the following FIGS. 1-3 are provided as exemplary diagrams of data processing environments in which embodiments of the present invention may be implemented. It should be appreciated that FIGS. 1-3 are only exemplary and are not intended to assert or imply any limitation with regard to the environments in which embodiments of the present invention may be implemented. Many modifications to the depicted environments may be made without departing from the spirit and scope of the present invention.

With reference now to the figures, FIG. 1 depicts a pictorial representation of a network of data processing systems in which embodiments of the present invention may be implemented. Network data processing system 100 is a network of computers in which embodiments of the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In accordance with an embodiment of the present invention, server 104 provides application integration tools to application developers for applications that are used on clients 108, 110, and 112. More particularly, server 104 may provide access to application integration tools that will allow two different front-end applications in two different formats to disseminate messages sent from each other.

In accordance with one preferred embodiment, a dynamic framework is provided for using a graphical user interface (GUI) for creating and editing message formats. This framework involves the development of user interface (UI) components for message data elements in the visualization and building of message formats, which may exist on storage 106. This framework may be provided through an editor mechanism on server 104 in the depicted example. The UI components and message data elements may be accessed, for example, using a browser client application on one of clients 108, 110, and 112.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for embodiments of the present invention.

Referring to FIG. 2, a block diagram of a data processing system that may be implemented as a server, such as server 104 in FIG. 1, is depicted in accordance with an embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer™ pSeries® system, a product of International Business Machines Corporation in Armonk, N.Y., running the Advanced Interactive Executive (AIX™) operating system or LINUX® operating system.

With reference now to FIG. 3, a block diagram of a data processing system is shown in which the present invention may be implemented. Data processing system 300 is an example of a computer, such as client 108 in FIG. 1, in which code or instructions implementing the processes of the present invention may be located. In the depicted example, data processing system 300 employs a hub architecture including a north bridge and memory controller hub (MCH) 308 and a south bridge and input/output (I/O) controller hub (ICH) 310. Processor 302, main memory 304, and graphics processor 318 are connected to MCH 308. Graphics processor 318 may be connected to the MCH through an accelerated graphics port (AGP), for example.

In the depicted example, local area network (LAN) adapter 312, audio adapter 316, keyboard and mouse adapter 320, modem 322, read only memory (ROM) 324, hard disk drive (HDD) 326, CD-ROM driver 330, universal serial bus (USB) ports and other communications ports 332, and PCI/PCIe devices 334 may be connected to ICH 310. PCI/PCIe devices may include, for example, Ethernet adapters, add-in cards, PC cards for notebook computers, etc. PCI uses a cardbus controller, while PCIe does not. ROM 324 may be, for example, a flash binary input/output system (BIOS). Hard disk drive 326 and CD-ROM drive 330 may use, for example, an integrated drive electronics (IDE) or serial advanced technology attachment (SATA) interface. A super I/O (SIO) device 336 may be connected to ICH 310.

An operating system runs on processor 302 and is used to coordinate and provide control of various components within data processing system 300 in FIG. 3. The operating system may be a commercially available operating system such as Windows XP™, which is available from Microsoft Corporation. An object oriented programming system, such as the Java™ programming system, may run in conjunction with the operating system and provides calls to the operating system from Java™ programs or applications executing on data processing system 300. “JAVA” is a trademark of Sun Microsystems, Inc.

Instructions for the operating system, the object-oriented programming system, and applications or programs are located on storage devices, such as hard disk drive 326, and may be loaded into main memory 304 for execution by processor 302. The processes of the present invention are performed by processor 302 using computer implemented instructions, which may be located in a memory such as, for example, main memory 304, memory 324, or in one or more peripheral devices 326 and 330.

Those of ordinary skill in the art will appreciate that the hardware in FIG. 3 may vary depending on the implementation. Other internal hardware or peripheral devices, such as flash memory, equivalent non-volatile memory, or optical disk drives and the like, may be used in addition to or in place of the hardware depicted in FIG. 3. Also, the processes of the present invention may be applied to a multiprocessor data processing system.

For example, data processing system 300 may be a personal digital assistant (PDA), which is configured with flash memory to provide non-volatile memory for storing operating system files and/or user-generated data. The depicted example in FIG. 3 and above-described examples are not meant to imply architectural limitations. For example, data processing system 300 also may be a tablet computer, laptop computer, or telephone device in addition to taking the form of a PDA.

The present invention provides a method, apparatus, and computer program product for using SSO processes to manage security credentials in a provisioning management system. Service access operations are provided that embed credential operations and matching algorithms. The present invention treats credential operations at a different level of abstraction and defines separate services to deal with authentication and authorization aspects. This is performed in order to be able to plug-in an external credential repository, which may be authentication/authorization provided by a third party entity.

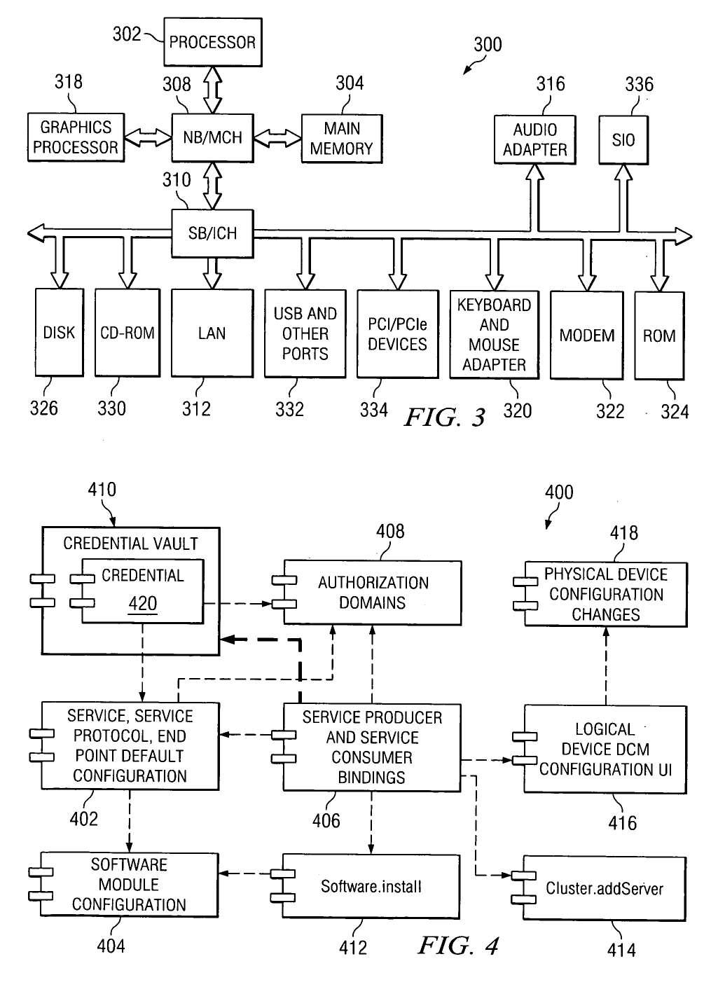

Turning now to FIG. 4, a functional block diagram of a security management system is depicted in accordance with an embodiment of the present invention. Security management system 400 is composed of numerous configuration modules, active components and a repository. Service, service protocol and end point default configuration module 402 is a module that groups configuration classes that defines services. A service is a generic capability offering, which is a system capability that can be provided or consumed. The consumer/provider aspects are captured independently by service bindings associated with the DcmObject representing the physical device and are conditioned by the software product used to provide or consume a service. The consumer service aspect is captured by a ClientSapBinding. The provider aspect is expressed by a ServiceAccessProtocolEndPoint instances. The service class captures the static description of a service and groups them in generic categories which may be, for example, File Transfer Service, Terminal Service, Authentication Service, etc.

A service access protocol (SAP) is an application protocol used to access the service, the network protocol type, and has bindings to map the service providers and service consumers to datacenter objects. The end points details, such as port, context, Uri, IP, etc., are configured on service providers and are captured in the ServiceAccessProtocolEndPoint class. This service consumer/service provider separation is made so a service consumer will only care about service access protocol while a service provider knows the end points access details. The consumer and provider are matched together using the CompatibleAppProtocol configuration class.

Software configuration module 404 groups the configuration classes that define software module/stack installation aspects. Software configuration module 404 usually includes service configuration aspects. Software configuration module 404 provides SAP capability. This relation is used to describe the fact that an underlying piece of software is used either to provide or to access a service. In case the software module provides a service, this class will have a link with the PepParamSetType used to get end point default values.

In the case where the software module provides a service client capability, this class will be linked with a SAP class. If SoftwareResourceParameters are used in software install configuration define service end points parameters, this aspect will be captured by PepSoftwareInstallParameterMap. SoftwareSapCapability will specify the ServiceAuthorizationDomain used in service host or service client configuration at software install time. The PepSoftwareInstallParameterMap is used to map SoftwareResourceTemplate install parameters with protocol end point (PEP) configuration parameters so that the parameter values used in software installation will also be used in Service End Point configuration.

Service producer and service consumer bindings 406 are bindings that represent active components that define the provider and consumer aspects involved in a service call. These bindings use authorization domains to negotiate security aspects. Service bindings are configured dynamically by the Software.install module 412 and Cluster.adServer module 414 components or can be configured manually by the user using a user interface designed for this purpose and links with the physical device configuration editor.

Service producer bindings use the ServiceAccessProtocolEndPoint class. If the service requires authorization, the subject instance of this class will point to instances of ServiceAuthorizationDomain. In this case the host is only accessible on the authorization domains, and their super domains, that are configured here. Instances where the ServiceAccessProtocolEndPoint class is created are:
1) when a software module that specifies a service host capability is installed. In this case a back reference to the SoftwareResource is created, and the SoftwareResource state will be checked to verify that the resource is running.
2) when a server is added to a cluster. In this case an instance of this class was configured on a cluster to serve as a template. The current instance associated with the moved server will point to the template instance (using CreatedFromTemplate association role). In this way a trace relationship is retained between a PEP definition at the container level and all the PEPs created using that definition.
3) configured directly from user interface (UI), with the intent of adding additional PEPs not configured at cluster level, servers configured outside the Tivoli Intelligent Orchestrator (TIO), or special servers, such as an external credentials vault server.

ProtocolEndPointParam is the value of the protocol end point runtime configuration, where the name and/or value parameter pairs are used to access the service. Runtime values come from a set of default values and/or from the SoftwareResourceTemplate parameters. The PepAuthorizationDomain stores the instances of the ServiceAccessProtocolEndPoint class, which are created together with the protocol end points, in all PEP instantiating use cases, and are used to bind an authorization domain with the PEP in a many-to-many relationship. The instances of the ServiceAccessProtocolEndPoint class also point to the credential found in the SAP or domain context. This pointer is used to manage credential changes or to keep a reference to an external credential proxy in order to manage its timing conditions. That is, to be able to keep in synch the physical layer with the datacenter model layer this back reference to the credential used to access a protocol end point under an authorization domain will be created and made persistent each time the physical layer is configured to use a different credential.

Service consumer bindings use the ClientSapBinding class that creates the binding between a SAP and a physical object that has a client able to access the service through that access protocol. Instances where the ClientSapBinding class is created are:
1) when a software module that specifies a service consumer capability is installed. In this case a back reference to the SoftwareResource is created, and the SoftwareResource state will be checked to verify that the software resource is running before invoking the service.
2) when a server is added to a cluster. In this case an instance of this class was configured on a cluster to serve as a template. The current instance associated with the moved server will point to the template instance (using CreatedFromTemplate association role). In this way we keep a trace relationship between a SAP definition at the container level with all the SAPs created using that definition.
3) configured directly from UI, with the intent of adding additional SAPs not configured at cluster level—servers configured outside TIO.

The ClientSapAuthorizationDomain stores the instances of ClientSapBinding class that are created together with the client service bindings (in all instantiating use cases) and are used to bind an authorization domain with a service client. The client authorization domain role is two fold: to define the domains of service providers the client is authorized to use and to define an authorization mechanism for service clients that can be linked to a user role. The client needs to provide the domain as a parameter in the service invocation call. If the domain is not specified, it will be inherited from the user role.

Service authorization domain module 408 holds authorization domain definitions. Authorization domains are provided by service clients and used by service providers to authorize the service call. Service authorization domain module 408 has a role which is two fold. The first role is to retrieve, or lookup, the credentials used to authenticate the service call the client is asking though an access protocol end point (host). The second role is to authorize a service call in the context of a client, host and a protocol end point. If the host, or more exactly the PEP, is involved in the service invocation is the same or under the client authorization domain, then the service call is authorized. If not explicitly given in the service call, a list of authorization domains is inherited from the TIO user role.

As an example of how authorization works, a client may be registered under the domain torolab.ibm.com and will be authorized to access a protocol end point registered under the domains, such as engineering.torolab.ibm.com and torolab.ibm.com, because client domain is the same or in a parent relationship with the host domain. The two domains, engineering.torolab.ibm.com and torolab.ibm.com, will not necessary use the same service credentials, but the client call is authorized because of the parent relationship.

An AuthorizationDomain receives the credentials used to authenticate the service call from a credential vault. TIO has its own credentials storage named InternalCredVault. By associating a TIO user role with an AuthorizationDomain, the authorization context can be extended with the user that asked the service to be performed. In this way, a service client can inherit user's authorization context.

External credential vault 410 is a repository that holds internal credentials vault 420. External credential vault 410 provides an application program interface (API) for credential retrieval. The Tivoli Intelligent Orchestrator (TIO) provides a default internal credential repository that is stored in internal database. Credentials are stored in credential vaults. The CredentialVaultConfiguration class configures the vault API and the required parameters to access it. There is one preconfigured entry in this class referring to the TIO credential vault, where the configuration TIO uses to store credentials internally in its own database. For all the others vault user needs to have access to, a new instance has to be defined in this class.

Each ServiceAuthorizationDomain is defined as belonging to a particular credential vault, either internal or external. The vault configuration instances defining an external vault will point to the protocol end point used to access it. This PEP will have its own credentials and authorization domain used to access the vault API. The parameters required to access the vault API are stored in a VaultApiParameter class.

TIO stores and manage credentials using this InternalCredVault class. For each ServiceAuthorizationDomain managed internally and each ServiceAccessProtocol, there will be one credential. Each InternalCredVault entry is equal to a tuple, such as AuthorizationDomain, SAP, or credential. To get the credential for a protocol end point access and an authorization domain, the InternalCredentialVault is used as a look-up.

Logical device data center model (DCM) configuration user interface (UI) module 416 plays a role in configuring the end points details for application templates (clusters) or particular devices. Using logical device DCM configuration UI module 416, the user can change service related settings, drop or add services, alter authorization mechanism, change credentials associated with a protocol end point. Physical device configuration changes module 418 is used to propagate some of the UI cases to the physical layer, and it is accomplished by workflows associated with a particular DCM change. For example, in some cases a credential change can be propagated to the physical layer. This layer will propose the changes under a list of deployment engine tasks that should be approved prior to execution.

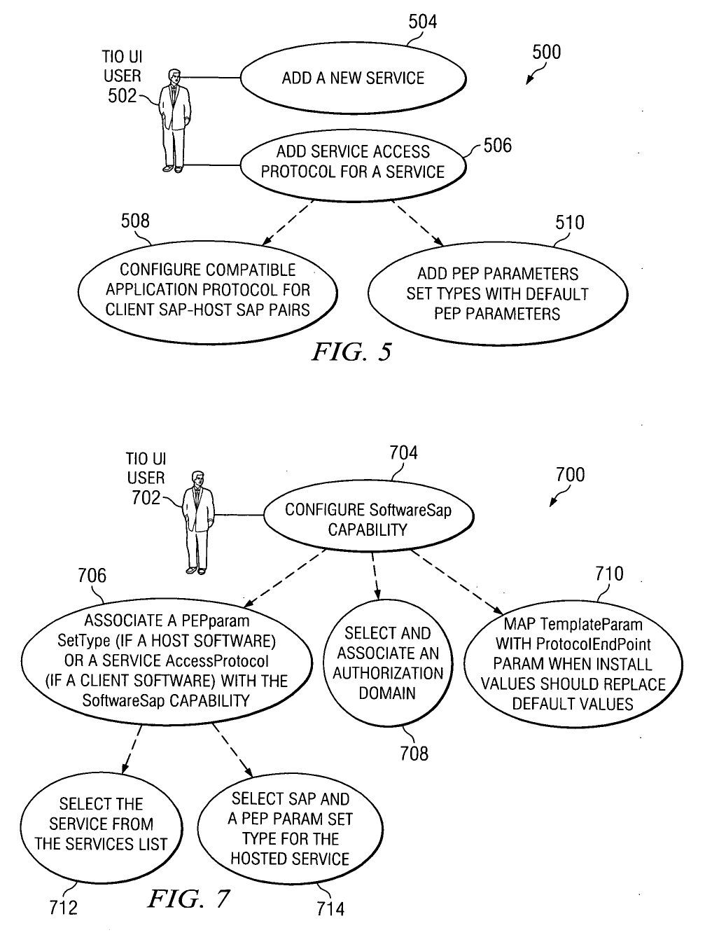

Turning now to FIG. 5, a diagram is depicted showing how the credential management system creates SAP static definitions in accordance with an embodiment of the present invention. Diagram 500 depicts the process performed by service, service protocol and end point default configuration module 402 of FIG. 4. In diagram 500, TIO UI user 502 may add a new service 504 or add a service access protocol for a particular service 506. If the user indicates that a SAP is to be added for a particular service, then the credential management system will either configure the CompatibleAppProtocol for the client SAP and the host SAP pairs 508 or add PEP parameter set types with default PEP parameters 510.

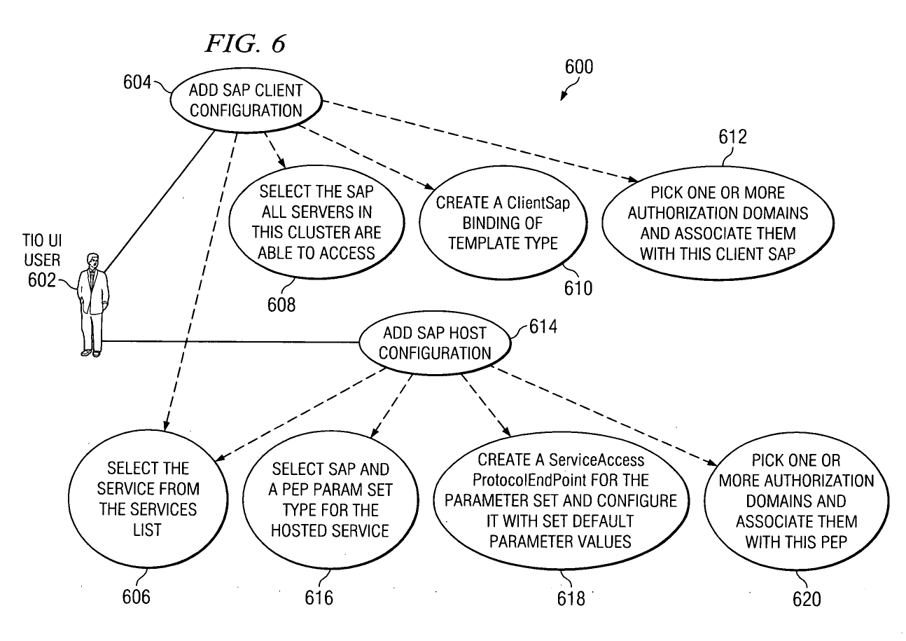

FIG. 6 is a diagram depicting a further description of host and client SAP configuration of FIG. 5 in accordance with an embodiment of the present invention. In diagram 600, if a SAP client configuration is to be added 604, TIO UI user 602 may select a service from a services list 606, select that all of the servers in the cluster are able to access this configuration 608, create a ClientSapBiding of a template type 610, or pick one or more AuthorizationDomain and associate them with the SAP client 612. In diagram 600, if a SAP host configuration is to be added 614, TIO UI user 602, may select a service from a services list 606, select SAP and PEP parameter set type for the hosted service 616, create a ServiceAccessProtocolEndPoint class for the parameter set and configure the class with set default parameter values 618, or pick one or more AuthorizationDomain and associate them with a PEP 620.

Turning now to FIG. 7, a diagram is depicted showing software module SAP configuration in accordance with an embodiment of the present invention. Diagram 700 depicts the process performed by software configuration module 404 of FIG. 4. In diagram 700, TIO UI user 702 is used to configure SoftwareSapCapability 704. In performing this configuration, TIO UI user 702 may associate a PEP parameter set type or a service access protocol depending on whether the software is host software or client software, respectively 706. TIO UI user 702 may also select and associate authorization domains 708 or map template parameters with a protocol end point parameter 710 when the TIO UI user 702 wants to replace the current default values. As part of associate a PEP parameter set type or a service access protocol 706, TIO UI user 702 may select a service for a list of services 712 or select SAP and PEP parameters set type for the hosted service 714 is the software being installed is host software.

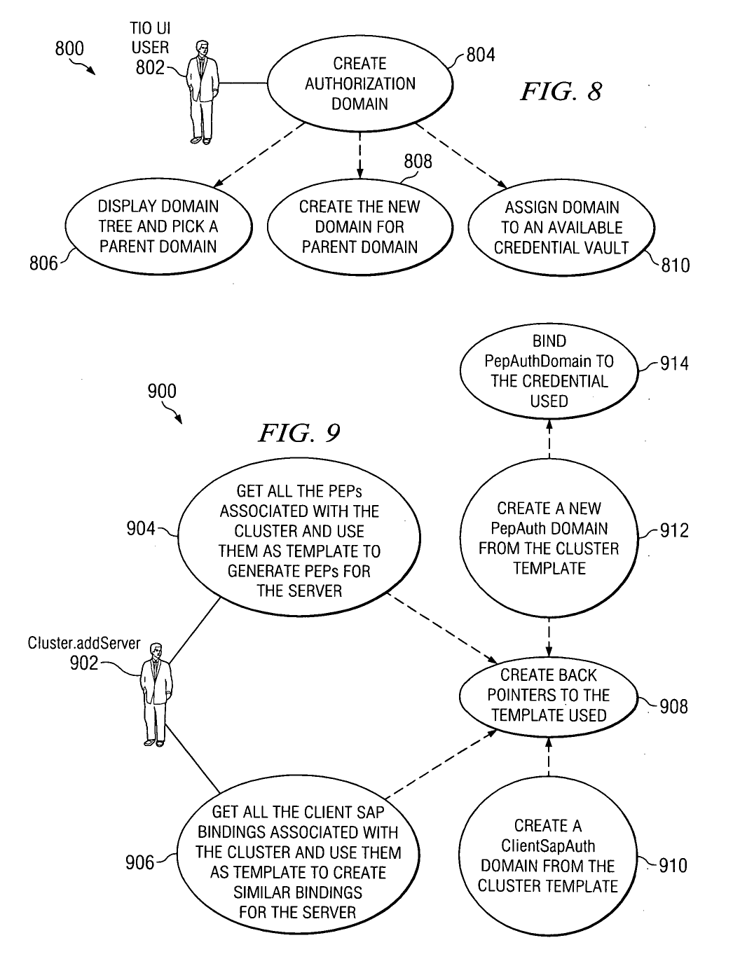

FIG. 8 is a diagram depicting authorization domain configuration in accordance with an embodiment of the present invention. Diagram 800 depicts the process performed by service authorization domain module 408 of FIG. 4. In creating AuthorizationDomain 804, TIO UI user 802 may display a domain tree and pick a parent domain from the domain tree 806, create a new domain as a parent domain 808 that is also added to the domain tree or assign a domain to an available credential vault 810.

FIG. 9 is a diagram depicting the configuration of end points when a server is added to a cluster in accordance with an embodiment of the present invention. Diagram 900 depicts the process performed in the Cluster.adServer module 414 of FIG. 4. If TIO UI user 902 indicates that a server is to be added to the cluster, all of the PEPs that are associated with the cluster are gathered and used as a template to generate the PEPs for the server that is being added 904. Additionally, all of the client SAP bindings associated with the cluster are also gathered and used as a template to create similar bindings for the server to be added 906. After the PEPs and bindings are created for the new server, back pointers are created which point back to the template for the new server 908. Then a ClientSapAuthorizationDomain for the cluster is created 910 as well as a new PepAuthorizationDomain for the cluster 912. Back pointers are created for these domains as well which relate back to the template 908. Finally a binding is created to the PepAuthorizationDomain to the credential used for this particular server 914.

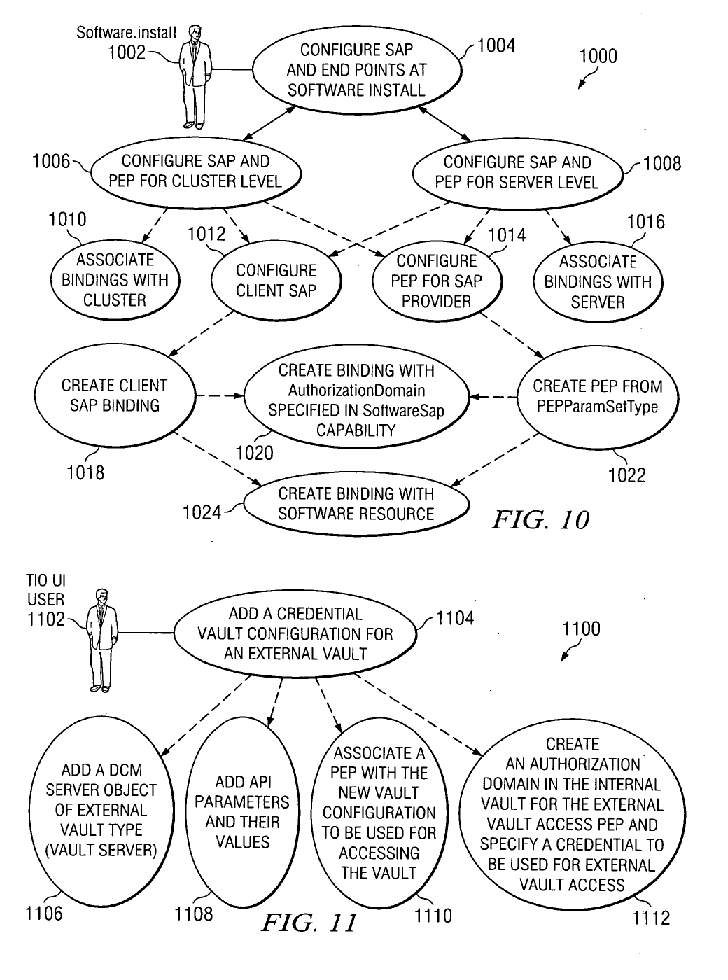

Turning now to FIG. 10, a diagram is depicted showing SAP and end point configuration at the time a piece of software is installed in accordance with an embodiment of the present invention. Diagram 1000 depicts the process performed by Software.install module 412 of FIG. 4. As software is installed by TIO UI user 1002 the SAP and end points are configured 1004. Upon install a decision is made as to whether the software should be installed for the cluster level 1006 or for the server level 1008. If the software is to be installed for the cluster level 1006, then the bindings for the software are associated with the cluster 1010, the software is configured for the client SAP 1012, and the protocol end points are configured for the SAP provider. To configure the software for the client SAP 1012, a ClientSapBinding is created 1018, which in turn creates a binding with AuthorizationDomain specified in the SoftwareSapCapability 1020 and a binding with the software resource is created 1024. To configure the PEP for a SAP provider 1014, a protocol end point is created from the PepParamSetType 1022, which in turn creates a binding with AuthorizationDomain specified in the SoftwareSapCapability 1020 and a binding with the software resource is created 1024.

If the software is to be installed for the server level 1008, then the bindings for the software are associated with the server 1016, the software is configured for the client SAP 1012, and the protocol end points are configured for the SAP provider. To configure the software for the client SAP 1012, a ClientSapBinding is created 1018, which in turn creates a binding with AuthorizationDomain specified in the SoftwareSapCapability 1020 and a binding with the software resource is created 1024. To configure the PEP for a SAP provider 1014, a protocol end point is created from the PepParamSetType 1022, which in turn creates a binding with AuthorizationDomain specified in the SoftwareSapCapability 1020 and a binding with the software resource is created 1024.

FIG. 11 is a diagram depicting the addition of a configuration to an external vault in accordance with an embodiment of the present invention. Diagram 1100 depicts the process performed in external credential vault 410 of FIG. 4. As TIO UI user 1102 indicates that a credential vault configuration is to be added to an external credential vault 1104, the user may add a DCM server object of a specified external vault type 1106, add API parameters to the external vault 1108, associate a PEP with a new vault configuration 1110, which is to be used for access the new vault, or create an authorization domain in the internal vault for the external vault access PEP and specify a credential to be used for external vault access 1112. It is important to remember, the Tivoli Intelligent Orchestrator (TIO) provides a default internal credential vault which is already preconfigured.

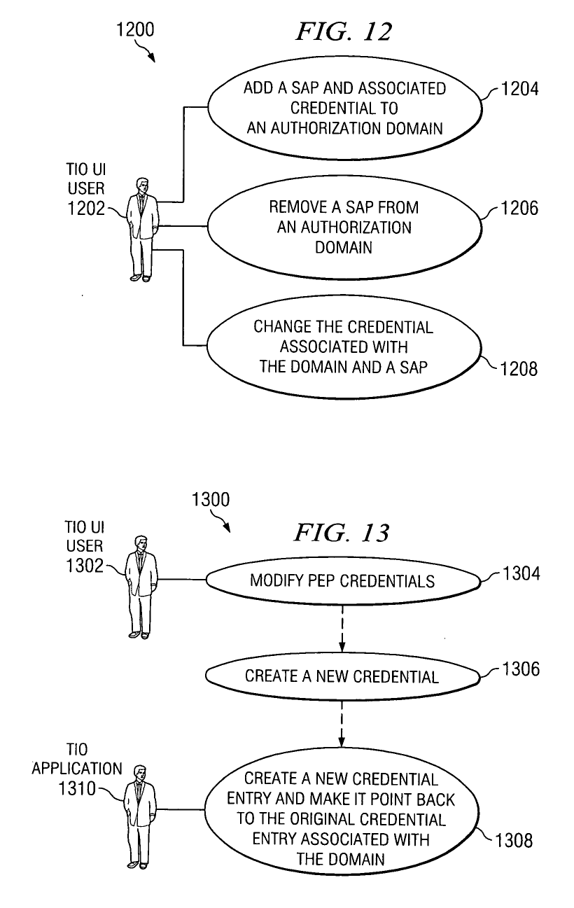

FIG. 12 is a diagram depicting the configuration of the internal vault in accordance with an embodiment of the present invention. Diagram 1200 depicts the process performed in credentials vault 420 of FIG. 4. As TIO UI user 1202 indicates that the internal credential vault configuration is to be modified, TIO UI user 1202 may add a SAP and associated credentials to an authorization domain 1204, remove a SAP from an authorization domain 1206, or change a credential that is already associated with a domain and/or a SAP 1208.

FIG. 13 is a diagram depicting the modification of a PEP credential in accordance with an embodiment of the present invention. Diagram 1300 depicts a process that may be performed on the credentials stored in credentials vault 420 of FIG. 4. If TIO UI user 1302 indicates that a modification is to be made to a PEP credential 1304, the current process does not modify the actual credential, rather creates a new credential 1306. Once the new credential is created, 1306, then a new credential entry is entered in a credential vault, such as credential vault 402 of FIG. 4, and a pointer is created that points back to the original credential entry, which was intended to be modified, associated with the specified domain 1308. Also an administrator may use TIO Application 1310 to create new credential entries and pointers associated with those credentials 1308.

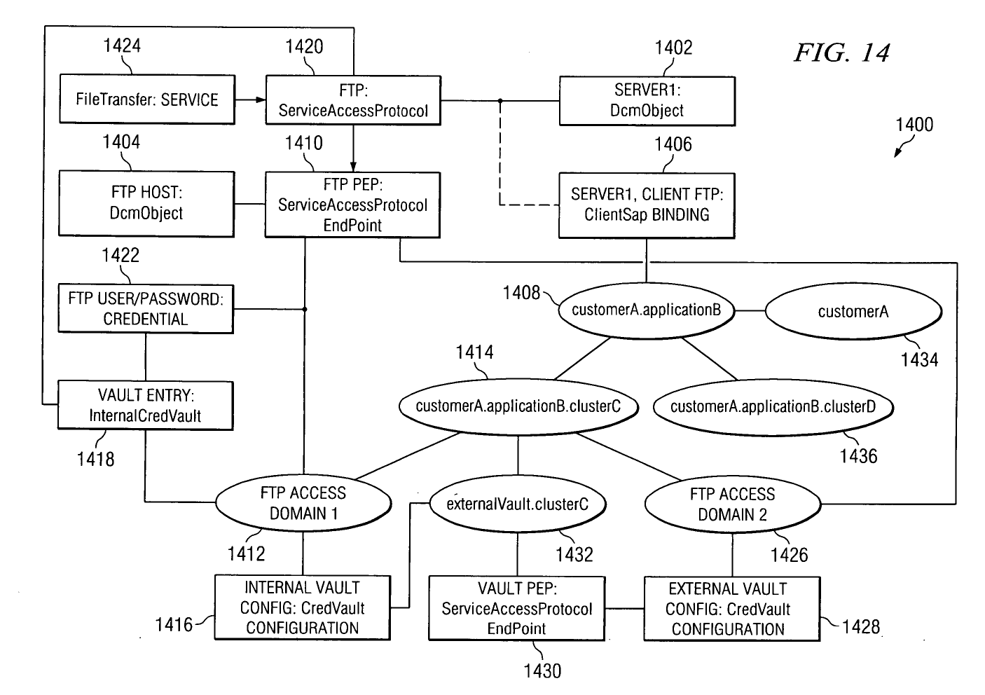

FIG. 14 is an authorization object model that is used in managing security credentials in accordance with an embodiment of the present invention. Authorization object model 1400 depicts an exemplary authorization process performed in authorization domain 408 of FIG. 4. In the exemplary domain structure shown in authorization object model 1400 domains are defined to mirror a customer application structure, although this definition does not limit in any way the following scenarios. Considering that a FTP client, Server1 DcmObject 1402, initiates a FTP call to a FTP server, FTP Host DcmObject 1404, the following scenarios provide examples of how the authorization process executes.

In scenario 1, Server1 Client FTP 1406 is assigned to customerA.applicationB 1408 authorization domain and FTP PEP 1410 is assigned to FTP access domain 1 1412. A service call from Server1 DcmObject 1402 may look like:
FileTransfer 1424 (file, Server1 DcmObject 1402, FTP Host DcmObject 1404, customerA.ApplicationB.clusterC 1414)
   Because the supplied domain, customerA.ApplicationB.clusterC 1414 is a sub-domain of the assigned client domain customerA.applicationB 1408, Server1 DcmObject 1402 is authorized to make the call under the given domain. The next step is to verify if the client domain includes access to the service host, and to find a PEP that can be used to access the service. The service host, FTP PEP 1410, has visibility under FTP access domain1 1412. Because FTP access domain1 1412 is a sub-domain of the given domain customerA.ApplicationB.clusterC 1414, the call is authorized, and the PEP (protocol end point) chosen for this service became FTP PEP 1410 under FTP access domain1 1412.

In a final step, authorization object module 1400 will retrieve the credentials to authenticate the client. These credentials are retrieved using the host domain FTP access domain1 1412. Because FTP access domain1 1412 is assigned to the internal credential repository 1416, a look-up in an InternalVault table will retrieve the vault entry, VaultEntry: InternalCredVault 1418, object that corresponds to the FTP access domain1 1412 and FTP service access protocol 1420 used. The FTP user/password: credential 1422 will be retrieved and used.

If the host PEP has been assigned to a credential under FTP access domain1 1412, then instead of a look-up in the InternalVault table, the credential under FTP access domain1 1412 will be used instead. This assignment was initially done to flag the fact that the host was configured to use a different credential than the one configured in the vault, which may be because it was previously changed with the intent to avoid a security breach.

In scenario 2, Server1 Client FTP 1406 is assigned to customerA.applicationB 1408 authorization domain, FTP PEP 1410 is assigned to FTP access domain 2 1426. A service call from Server1 DcmObject 1402 may look like:
FileTransfer 1424 (file, Server1 DcmObject 1402, FTP Host DcmObject 1404, FTP access domain2 1426)
   Because the supplied domain, FTP access domain2 1426 is a sub-domain of the assigned client domain customerA.applicationB 1408, client is authorized to make the call under FTP access domain2 1426. The next step is to verify if the client domain includes access to the service host, and to find a PEP that can be used to access the service. The service host, FTP PEP 1410, has visibility under the domain FTP access domain2 1426. Because this domain is the same as the given domain, the call is authorized, and the PEP (protocol end point) chosen for this service became FTP PEP 1410 under FTP access domain2 1426.

In a final step, authorization object module 1400 will retrieve the credentials to authenticate the client. These credentials are retrieved using the host domain FTP access domain2 1426. Because host domain is assigned to an external credential repository 1428, the external vault API will be used to retrieve the credentials. The vault API will be invoked by calling an authentication service using the assigned protocol end point, which in this case is vault PEP: ServiceAccessProtocolEndPoint 1430. Vault PEP: ServiceAccessProtocolEndPoint 1430 was previously configured and assigned to the credential vault configuration, external vault configuration: CredVaultConfiguration 1428. Vault PEP: ServiceAccessProtocolEndPoint 1430 operates under the authorization domain, external vault.clusterC 1432 and because it is a sub-domain of the client assigned domains, the client is authorized to make initiate the vault API. In the same way as described above, the credentials to make the vault API are retrieved from internal vault and the vault API is called. The call will result in a set of credentials that will be used to make the FTP access.

Immediately after the credentials are obtained from the external vault 1428, a credential entry to serve as a proxy will be created and associated with the {[vault PEP: ServiceAccessProtocolEndPoint 1430] [external vault.clusterC 1432]} tuple. The credential proxy created will hold usage conditions and concurrency flags to mark the credential usage. After the operation completes, vault PEP: ServiceAccessProtocolEndPoint 1430 will be called again to release the credential in the external vault.

In scenario 3, Server1 Client FTP 1406 is assigned to customerA.applicationB 1408 authorization domain, FTP PEP 1410 is assigned to FTP access domain 1 1412. A service call from Server1 DcmObject 1402 may look like:
FileTransfer 1424 (file, Server1 DcmObject 1402, FTP Host DcmObject 1404, customers 1434)
   In this case the client asks a service under a super-domain customerA 1434. CustomerA 1434 could be inherited from a TIO user role. In this case authorization procedure translates to: “try to acquire the service by checking all authorization domains client was assigned to, that are visible under the super-domain specified. Because assigned client domain, customerA.applicationB 1408, is a sub-domain of the supplied domain customerA 1434, client is authorized to make the call under the customerA.applicationB 1408 domain. If a client has more assigned domains, all which are sub-domains of the given one will be checked in the search for one authorized call to a host PEP. First match will be used. The next steps are the same as in Scenario 1, with the observation that the analyzed domains are all client assigned domains that are sub-domains of customerA 1434.

In scenario 4, Server1 Client FTP 1406 is assigned to customerA.applicationB 1408 authorization domain, FTP PEP 1410 is assigned to FTP access domain 1 1412 and the service call looks like this:
FileTransfer 1424 (file, Server1 DcmObject 1402, FTP Host DcmObject 1404)
   In this case the client asks a service under all domains assigned to the client, customerA.applicationB 1408, customerA.applicationB.clusterC 1414 and customerA.applicationB.clusterD 1436. Assigned client domains will be considered one by one in the search for an authorized (visible) protocol end point. This scenario resumes to Scenario 1, for each assigned client domain.

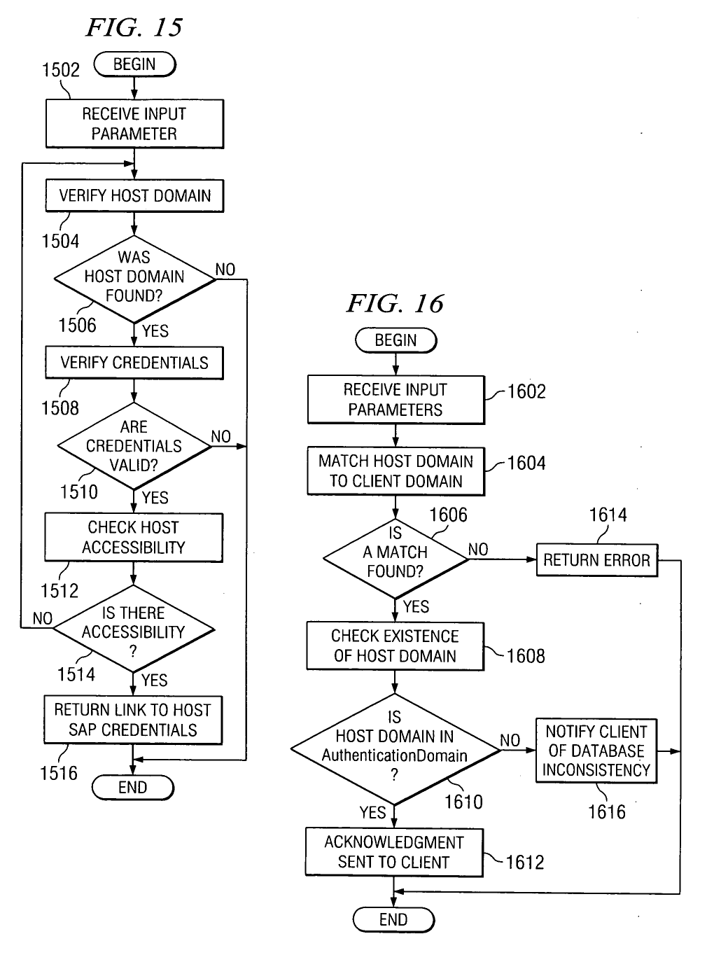

FIG. 15 is a flowchart illustrating the operation of obtaining host accessibility from a client in accordance with an embodiment of the present invention. As the operation begins, a request is received from a client specifying particular parameters (step 1502). The request may be a single-sign-on (SSO) request and all operation or processes may derive from the SSO request. From the particular parameters the client domain is searched for the existence of the host domain (step 1504). If the host domain is not found (step 1506), the operation ends. If the host domain is found (step 1506), the credentials from a client credential vault are verified (step 1508). If the credentials are not valid (step 1510), the operation ends. If the credentials are valid (step 1510), the host accessibility from the client domain is checked (step 1512). If there is not accessibility to the host from the client domain (step 1514), the operation returns to step 1504 to verify the client domain. If there is accessibility to the host (step 1514), the links to the host SAP credentials are obtained and sent to the client (step 1516) with the operation ending thereafter.

FIG. 16 is a flowchart illustrating the operation of checking client access credentials to an authentication domain in accordance with an embodiment of the present invention. This flowchart further defines the operation performed in step 1508 of FIG. 15. As the operation begins, a request is received from a client specifying particular parameters (step 1602). If the client is setup to have access to more than one host domain, a match is made of the requested host domain to the domains listed at the client (step 1604). If a match is found (step 1606), the existence of the domain is checked in the AuthenticationDomain list at the requested host, which is specified in the request parameters (step 1608). If there is a domain match found in the AuthenticationDomain database of the host (step 1610), an acknowledgment is sent to the client (step 1612) and the operation ends. If no domain match is found in the AuthenticationDomain database of the host (step 1610), the client is notified of the database inconsistency (step 1616) and the operation ends. Returning to step 1606, if no match is found, then an error is returned to the client (step 1614) and the operation ends.

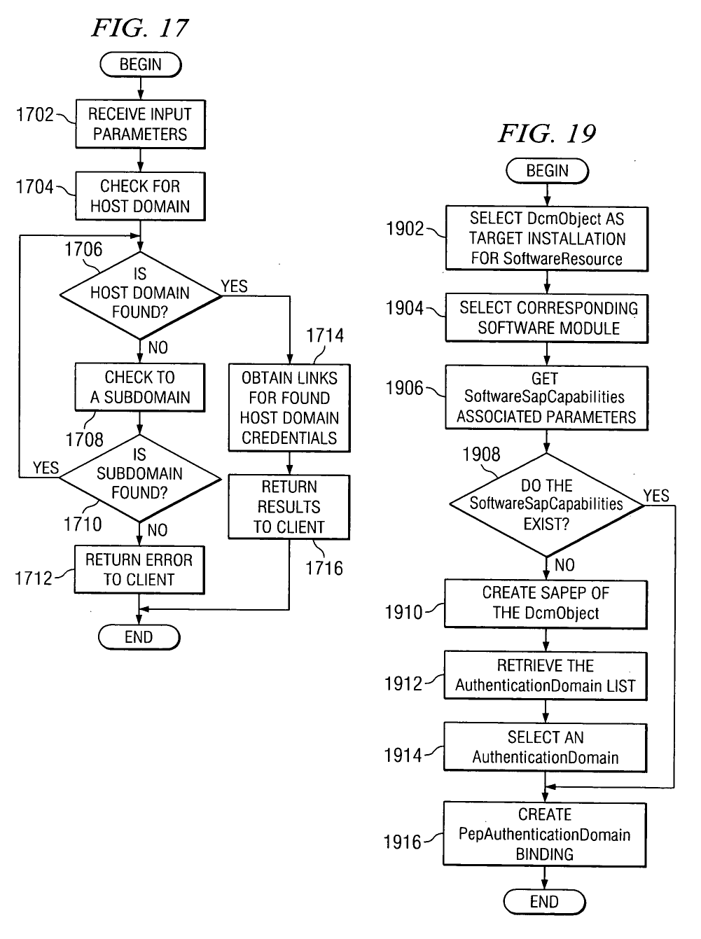

FIG. 17 is a flowchart illustrating the operation of checking host accessibility from a client domain in accordance with an embodiment of the present invention. This flowchart further defines the operation performed in step 1512 of FIG. 15. As the operation begins, a request is received from a client specifying particular parameters (step 1702). Based on the parameters specified in the client request a host domain is determined (step 1704). If a host domain is found (step 1706), the links to the host SAP credentials are obtained (step 1714) and sent to the client (step 1716) with the operation ending thereafter. If the host domain is not found (step 1706), a check of the sub-domains of the host is made (step 1708). If no sub-domain to the host is found (step 1710), an error is returned to the client (step 1712) and the operation ends thereafter. If a sub-domain is found (step 1710), the operation returns to step 1706 indicating that a domain has been found and the links to the host SAP credentials are obtained (step 1714) and sent to the client (step 1716) with the operation ending thereafter.

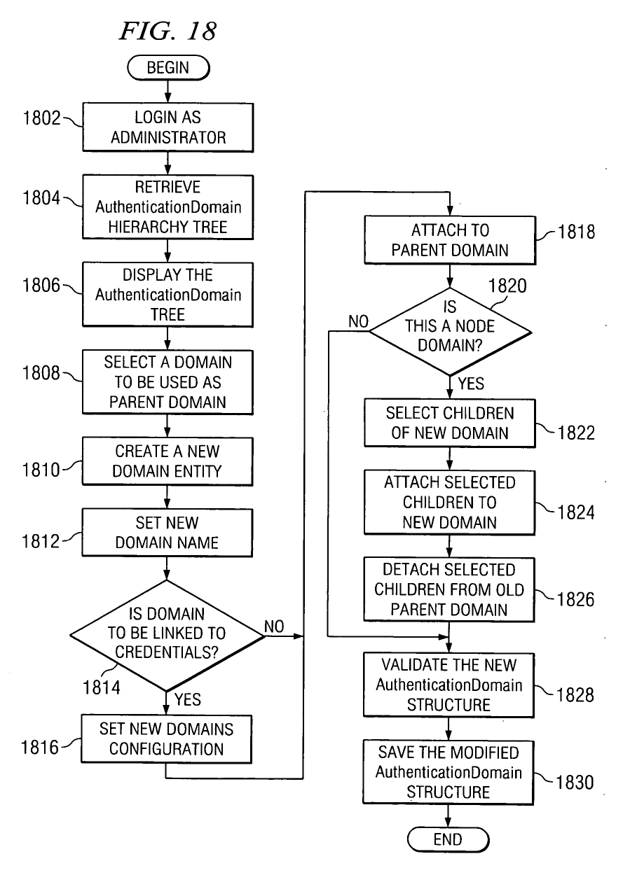

FIG. 18 is a flowchart illustrating the operation of creating a new domain at the host in accordance with an embodiment of the present invention. As the operation beings a user will login as an AuthenticationDomain administrator (step 1802). Upon login, the AuthenticationDomain database hierarchy tree is retrieved form the host (step 1804). The tree is displayed to the user (step 1806) from which the user selects a domain that is to be used as a parent domain (step 1808). A new domain entity is created (step 1810) and is set in the AuthenticationDomain database hierarchy tree (step 1812). Then the user has to decide if the domain is to be linked to the credentials in the credential vault of the parent domain or to have separate credentials in a separate credential vault (step 1814). If the parent credentials are to be used, the new domain is attached to the parent credential vault (step 1818). If new credentials are to be used, the new domain configurations are established specifying the credentials and the credential vault (step 1816) and the new configuration is attached to the parent credential vault (step 1818).

If the new domain is to be an intermediate node domain (step 1820), then one or more children domains may be selected from AuthenticationDomain database hierarchy tree (step 1822) and attached to the new domain (step 1824). After the child domains are attached to the new domain (step 1824), the domains are detached from the old parent domain (step 1826). The user then validates the new AuthenticationDomain database structure (step 1828) and the modified AuthenticationDomain database structure is saved at the host (step 1830) with the operation ending thereafter. Returning to step 1820, if the new domain is not to be an intermediate node domain but a leaf domain (step 1820), the operation skips to step 1828 where the user validates the new AuthenticationDomain database structure and then saves the modified AuthenticationDomain database structure (step 1830) with the operation ending thereafter.

FIG. 19 is a flowchart illustrating the operation of installing and configuring a software resource on a host in accordance with an embodiment of the present invention. As the operation begins a DcmObject is selected as the target installation device for the SoftwareResource (step 1902). A software module corresponding to the SoftwareResource is selected (step 1904) and the SoftwareSapCapabilities that are associated with the parameters of the DcmObject are searched for (step 1906). If the SoftwareSapCapabilities for the DcmObject exist, then a bind is created to the PepAuthenticationDomain (step 1916) with the process ending thereafter. If the SoftwareSapCapabilities for the DcmObject do not exist (step 1908), a ServiceAccessProtocolEndPoint (SAPEP) is created (step 1910). The AuthenticationDomain database is then retrieved from the host (step 1912) and a domain is selected from the AuthenticationDomain database (step 1914). Finally a bind is created to the PepAuthenticationDomain (step 1916) with the process ending thereafter.

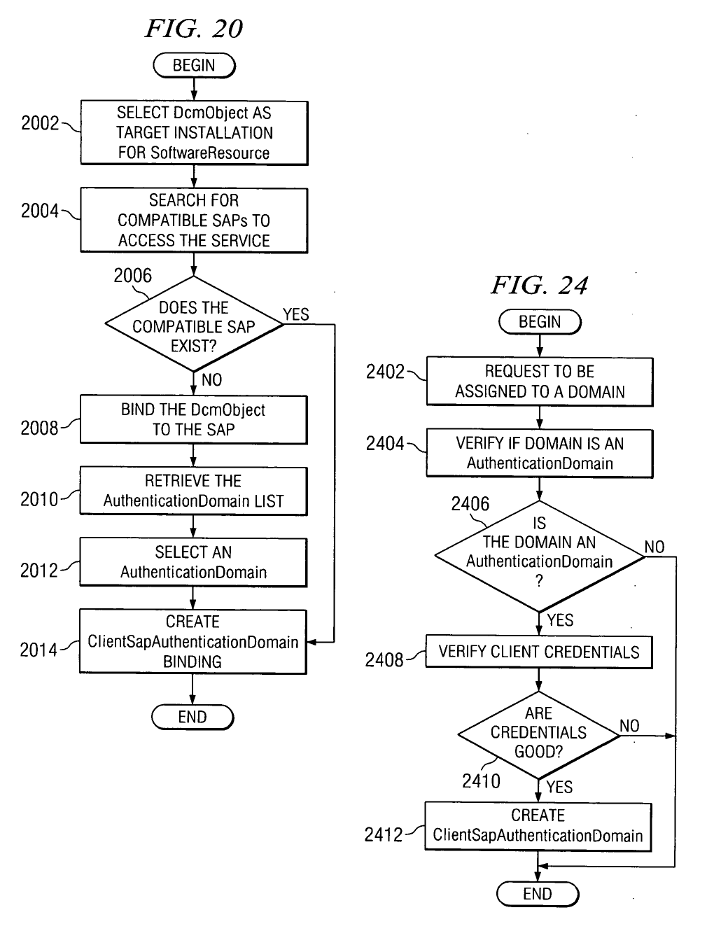

FIG. 20 is a flowchart illustrating the operation of installing and configuring a software resource on a client in accordance with an embodiment of the present invention. As the operation begins a DcmObject is selected as the target installation device for the SoftwareResource (step 2002). A compatible SAP is searched for to access the service based on the SoftwareResource (step 2004). If a compatible SAP exists for the service (step 2006), then a bind is created to the ClientSapAuthenticationDomain (step 2014) with the process ending thereafter. If a compatible SAP does not exist for the service (step 2006), then new SAP access to the service is created and bound to the DcmObject (step 2008). The AuthenticationDomain database is then retrieved from the host (step 2010) and a domain is selected from the AuthenticationDomain database (step 2012). Finally a bind is created to the ClientSapAuthenticationDomain (step 2014) with the process ending thereafter.

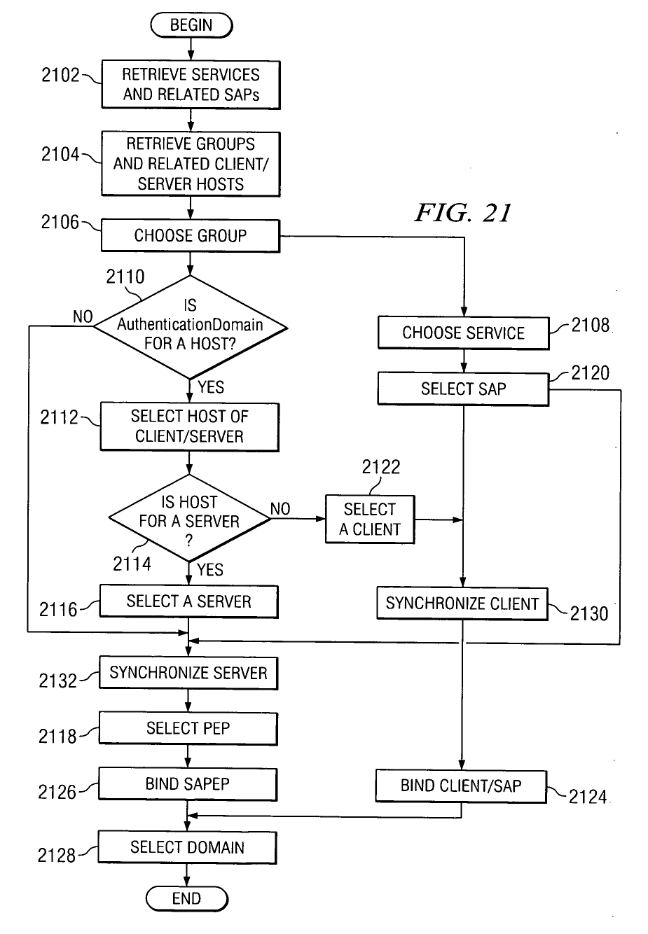

FIG. 21 is a flowchart illustrating the operation of selecting an authentication domain in accordance with an embodiment of the present invention. As the operation begins, an administrator indicates that authentication domain is to be added and the services and related SAPs are retrieved from the host (step 2102). Also retrieved from the host are the host are the groups and related client/server hosts (step 2104). The administrator then chooses the group where the authentication domain is to be added (step 2106). At this point, the operation starts different tasks that will have to be synchronized at a later time. Upon choosing a group (step 2106), the administrator will choose a service (step 2108) and select a SAP for the service (step 2120). The operation then proceeds to steps 2130 and 2132, where this portion of the operation holds until other tasks are completed.

Returning to step 2106, upon choosing a group a determination is made as to whether the authentication domain is for a host (step 2110). If the authentication domain is for a host (step 2110), the administrator must select a host for the client/server (step 2112). If the host is not for a server but for a client (step 2114), the administrator then selects the client (step 2122) and the operation proceeds to step 2130. At step 2130 a client synchronization is performed that ensures that the process from step 2120 and step 2122 both complete. Then the operation proceeds to step 2124 a bind is performed between the client and the selected SAP. A domain is selected at step 2128 with the operation ending thereafter.

Returning to step 2114, if the host is for a server, the administrator selects a server (step 2116). The operation then proceeds to step 2132 where this portion of the operation holds until other tasks are completed. Returning to step 2110, if the authentication domain is not for a host, the operation proceeds to step 2132 where server synchronization is performed between steps 2110, 2116 and 2120. At step 2132 a server synchronization is performed that ensures that the process from steps 2110, 2116 and 2120 complete. Then the operation proceeds to step 2118 where a protocol end point is selected and bound to a ServiceAccessProtocolEndPoint (step 2126). Then a domain is selected at step 2128 with the operation ending thereafter.

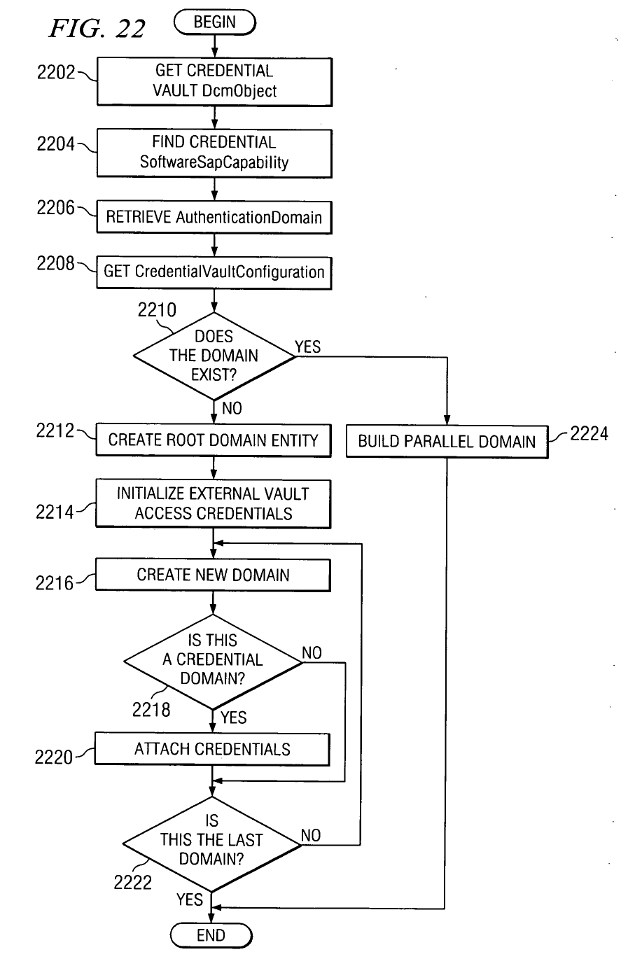

FIG. 22 is a flowchart illustrating the operation of creating an initial authentication domain in accordance with an embodiment of the present invention. As the operation begins, a credential vault DcmObject is obtained (step 2202) and SoftwareSapCapability is found for the credentials of the DcmObject (step 2204). Additionally, the AuthenticationDomain database is retrieved (step 2206) as well as the CredentialVaultConfiguration (step 2208). If a domain based on these values already exists (step 2210), a parallel domain is built (step 2224) with the process ending thereafter.

Returning to step 2210, if a domain the based on these values does not exist, a root domain entity is created (step 2212) and external vault access credentials are created (step 2214). Then a new domain is created (step 2216) and a determination is made as to whether the new domain is a credential domain (step 2218). If the new domain is not a credential domain (step 2218), then the operation makes a determination as to whether this is the last domain to be added (step 2222). If the new domain is the last domain to be added (step 2222), the operation ends. If the new domain is not the last domain to be added, the operation returns to step 2216. Returning to step 2218, if the new domain is a credential domain (step 2218), credentials are attached to the new domain (step 2220). The operation then proceeds to step 2222 and continues as previously described.

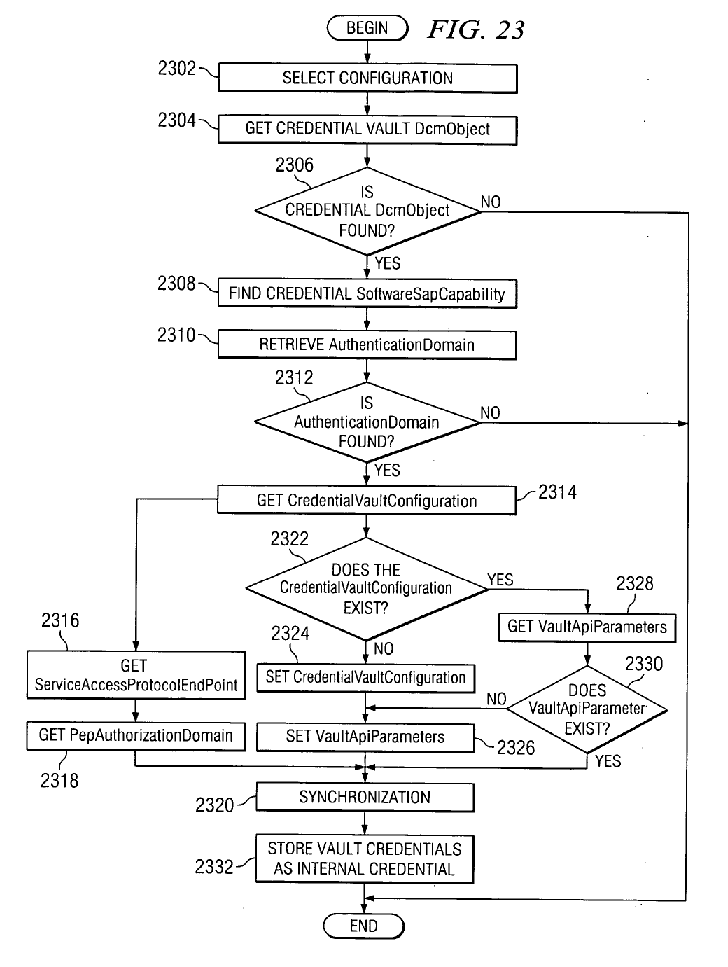

FIG. 23 is a flowchart illustrating the operation of initializing external vault credentials in accordance with an embodiment of the present invention. As the operation begins, a configuration of a DcmObject is selected in which to initialize the external vault credentials (step 2302). The credential vault of the DcmObject is attempted to be retrieved (step 2304). If the credentials vault of the DcmObject is not found (step 2306), the operation ends. If the credentials vault of the DcmObject is found (step 2306), then credential SoftwareSapCapability is located (step 2308). The AuthenticationDomain database is retrieved (step 2310) and a determination is made as to whether the domain of the DcmObject is in the AuthenticationDomain database (step 2312). If the AuthenticationDomain for the DcmObject is not found (step 2312), then the operation ends.

If the AuthenticationDomain for the DcmObject is found (step 2312) then the CredentialVaultConfiguration for the AuthenticationDomain is retrieved (step 2314). At this point the operation starts different tasks that will have to be synchronized at a later time. The first task is to retrieve the ServiceAccessProtocolEndPoint for the DcmObject (step 2316) and retrieve the PepAuthorizationDomain (2318). The operation then proceeds to step 2320 where this portion of the operation holds until other tasks are completed. The second task initiated from step 2314 is in response to verifying that the CredentialVaultConfiguration exists (step 2322). If the CredentialVaultConfiguration exists (step 2322), then the VaultApiParameters are attempted to be retrieved (step 2328). If the VaultApiParameters exist (step 2330), then the operation proceeds to step 2320 where this portion of the operation holds until the other tasks complete.

Returning to step 2322, if a CredentialVaultConfiguration does not exist a CredentialVaultConfiguration is set for the DcmObject (step 2324) and VaultApiParameters are also set for the DcmObject (step 2326). If at step 2330, where the CredentialVaultConfiguration exists but the VaultApiParameters do not, the operation proceeds to step 2326 where VaultApiParameters are set for the DcmObject. From step 2326 the operation proceeds to step 2320 where a synchronization of step 2318 and step 2330 or step 2326 is made. After synchronizing at step 2320, the vault credentials are then stored as internal vault credentials for the DcmObject (step 2332) and the operation ends.

FIG. 24 is a flowchart illustrating the operation of assigning a domain to a client in accordance with an embodiment of the present invention. As the operation begins, the client sends a request to be assigned to a domain (step 2402). Verification is made as to whether the requested domain exists in the AuthenticationDomain database (Step 2404). If in a determination that the domain does not exist in the AuthenticationDomain database (step 2406), then the operation ends. If in a determination that the domain does exist in the AuthenticationDomain database (step 2406), then the credentials from the client are verified (step 2408). If in a determination that the credentials for the client are not good (step 2410), then the operation ends. If in a determination that the credentials for the client are good (step 2410), then a ClientSapAuthenticationDomain is created for the client (step 2412) and the operation ends.

Thus, the embodiments of the present invention provide a method, apparatus, and computer program product for using SSO processes to manage security credentials in a provisioning management system. Service access operations are provided that embed credential operations and matching algorithms. Embodiments of the present invention treat credential operations at a different level of abstraction and define separate services to deal with authentication and authorization aspects. This is performed in order to be able to plug-in an external credential repository, which may be authentication/authorization provided by a third party entity.

It is important to note that while the embodiments of the present invention have been described in the context of a fully functioning data processing system, those of ordinary skill in the art will appreciate that the processes of the embodiments of the present invention are capable of being distributed in the form of a computer usable medium of instructions and a variety of forms and that the embodiments of the present invention apply equally regardless of the particular type of signal bearing media actually used to carry out the distribution. Examples of computer usable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer usable media may take the form of coded formats that are decoded for actual use in a particular data processing system.

The description of the embodiments of the present invention have been presented for purposes of illustration and description, and were not intended to be exhaustive or limited to the invention in the form disclosed. Many modifications and variations will be apparent to those of ordinary skill in the art. The embodiments were chosen and described in order to best explain the principles of the invention, the practical application, and to enable others of ordinary skill in the art to understand the invention for various embodiments with various modifications as are suited to the particular use contemplated.

What is claimed is:

1. A method for managing security credentials comprising:
receiving a request from a client, wherein the request includes input parameters and wherein the input parameters define a host domain of a host;
verifying the host domain;
in response to the host domain being verified, verifying client credentials, wherein the client credentials indicate accessibility to the host domain;
in response to the client credentials being verified, checking the host accessibility; and
in response to the host being accessible, returning to the client a link to service access protocol credentials of the host.

2. The method of claim 1, wherein the step of verifying client credentials further comprises:
matching the host domain to client predefined domains;
in response to a match of the host domain, checking the existence of the host domain in a data structure; and
in response to the existence of the host domain in the data structure, sending an acknowledgement to the client.

3. The method of claim 2, further comprising:
in response to a non-match of the host domain, requesting the addition of a new domain to the data structure;
retrieving the data structure from the host;
selecting a parent domain from the data structure;
creating the new domain name;
setting the new domain name in the data structure to form a modified data structure;
determining if credentials are to be associated with the new domain;
in response to an indication that credentials are to be associated with the new domain, setting a configuration specifying the credentials that are to be associated in the modified data structure;
attaching the new domain to the parent domain;
validating the modified data structure; and
storing the modified data structure on the host.

4. The method of claim 3, further comprising:
determining if the new domain is to be a node domain;
in response to an indication that the new domain is to be a node domain, selecting at least one child domain from the data structure;
attaching the at least one child domain to the new domain; and
detaching the at least one child domain from the parent domain.

5. The method of claim 3, wherein storing the modified data structure on the host replaces the previous data structure.

6. The method of claim 1, wherein the step of checking host accessibility further comprises:
checking as to whether the host domain is found in a data structure; and
in response to the existence of the host domain in the data structure, sending an acknowledgement to the client.

7. The method of claim 6, further comprising:
in response the nonexistence of the host domain in the data structure, checking for a sub-domain in the data structure; and
in response to the existence of a sub-domain, sending an acknowledgement to the client.

8. The method of claim 1, wherein the request from the client is a particular request for access to a new domain and the method for accessing the new domain comprises:
verifying if the new domain exists in a data structure;
in response to the new domain existing in the data structure, verifying the client credentials for access to the new domain; and
creating an indication of access to the new domain in a data structure on the client.

9. The method of claim 1, wherein the request from the client is for access to a service.

10. The method of claim 1, wherein the request is a single sign on request.

11. A data processing system comprising:
a bus system;
a communications system connected to the bus system;
a memory connected to the bus system, wherein the memory includes a set of instructions;
an instruction execution unit; and
a processing unit connected to the bus system, wherein the processing unit executes the set of instructions to receive a request from a client, wherein the request includes input parameters and wherein the input parameters define a host domain of a host; verify the host domain; verify client credentials in response to the host domain being verified, wherein the client credentials indicate accessibility to the host domain; check the host accessibility in response to the client credentials being verified; and return to the client a link to service access protocol credentials of the host in response to the host being accessible.

12. The data processing system of claim 11, wherein the processing unit executing the set of instructions to verify the client credentials further comprises the processing unit executing a set of instructions to match the host domain to client predefined domains; check the existence of the host domain in a data structure in response to a match of the host domain; and send an acknowledgement to the client in response to the existence of the host domain in the data structure.

13. The data processing system of claim 12, wherein the processing unit executes a further set of instructions to request the addition of a new domain to the data structure in response to a non-match of the host domain; retrieve the data structure from the host; select a parent domain from the data structure; create the new domain name; set the new domain name in the data structure to form a modified data structure; determine if credentials are to be associated with the new domain; set a configuration specifying the credentials that are to be associated in the modified data structure in response to an indication that credentials are to be associated with the new domain; attach the new domain to the parent domain; validate the modified data structure; and store the modified data structure on the host.

14. The data processing system of claim 13, wherein the processing unit executes a further set of instructions to determine if the new domain is to be a node domain; select at least one child domain from the data structure in response to an indication that the new domain is to be a node domain; attach the at least one child domain to the new domain; and detach the at least one child domain from the parent domain.

15. The data processing system of claim 11, wherein the processing unit executing the set of instructions to check host accessibility further comprises the processing unit executing a set of instructions to check as to whether the host domain is found in a data structure; and send an acknowledgement to the client in response to the existence of the host domain in the data structure.

16. The data processing system of claim 15, wherein the processing unit executes a further set of instructions to check for a sub-domain in the data structure in response the nonexistence of the host domain in the data structure; and sending an acknowledgement to the client in response to the existence of a sub-domain.

17. The data processing system of claim 11, wherein the request from the client is a particular request for access to a new domain and the processing unit, in order to access the new domain, executes a further set of instructions to verify if the new domain exists in a data structure; verifying the client credentials for access to the new domain in response to the new domain existing in the data structure; and create an indication of access to the new domain in a data structure on the client.

18. A computer program product for managing security credentials the computer program product comprising:
a computer usable medium embodying one or more instructions executable by the computer, the one or more instructions comprising:
first instructions for receiving a request from a client, wherein the request includes input parameters and wherein the input parameters define a host domain of a host;
second instructions for verifying the host domain;
in response to the host domain being verified, third instructions for verifying client credentials, wherein the client credentials indicate accessibility to the host domain;
in response to the client credentials being verified, fourth instructions for checking the host accessibility; and
in response to the host being accessible, fifth instructions for returning to the client a link to service access protocol credentials of the host.

19. The computer program product of claim 18, wherein the third instructions for verifying client credentials further comprises:
first sub-instructions for matching the host domain to client predefined domains;
in response to a match of the host domain, second sub-instructions for checking the existence of the host domain in a data structure; and
in response to the existence of the host domain in the data structure, third sub-instructions for sending an acknowledgement to the client.

20. The computer program product of claim 19, further comprising:
in response to a non-match of the host domain, first sub-instructions for requesting the addition of a new domain to the data structure;
second sub-instructions for retrieving the data structure from the host;
third sub-instructions for selecting a parent domain from the data structure;
fourth sub-instructions for creating the new domain name;
fifth sub-instructions for setting the new domain name in the data structure to form a modified data structure;
sixth sub-instructions for determining if credentials are to be associated with the new domain;
in response to an indication that credentials are to be associated with the new domain, seventh sub-instructions for setting a configuration specifying the credentials that are to be associated in the modified data structure;
eighth sub-instructions for attaching the new domain to the parent domain;
ninth sub-instructions for validating the modified data structure; and
tenth sub-instructions for storing the modified data structure on the host.

21. The computer program product of claim 20, further comprising:
first sub-instructions for determining if the new domain is to be a node domain;
in response to an indication that the new domain is to be a node domain, second sub-instructions for selecting at least one child domain from the data structure;
third sub-instructions for attaching the at least one child domain to the new domain; and
fourth sub-instructions for detaching the at least one child domain from the parent domain.

22. The computer program product of claim 18, wherein the fourth instructions for checking host accessibility further comprises:
first sub-instructions for checking as to whether the host domain is found in a data structure; and
in response to the existence of the host domain in the data structure, second sub-instructions for sending an acknowledgement to the client.

22. The computer program product of claim 18, further comprising:
in response the nonexistence of the host domain in the data structure, first sub-instructions for checking for a sub-domain in the data structure; and
in response to the existence of a sub-domain, second sub-instructions for sending an acknowledgement to the client.

23. The computer program product of claim 18, wherein the request from the client is a particular request for access to a new domain and the instructions for accessing the new domain comprises:
first sub-instructions for verifying if the new domain exists in a data structure;
in response to the new domain existing in the data structure, second sub-instructions for verifying the client credentials for access to the new domain; and
third sub-instructions for creating an indication of access to the new domain in a data structure on the client.
